(19) United States
(12) Patent Application Publication
(10) Pub. No.: US 2019/0232858 A1
(43) Pub. Date: Aug. 1, 2019

(54) EASY LIFT RACK SYSTEM

(71) Applicant: DENNIS RAY DICKSON, ALEXANDRIA, LA (US)

(72) Inventor: DENNIS RAY DICKSON, ALEXANDRIA, LA (US)

(21) Appl. No.: 16/231,173

(22) Filed: Dec. 21, 2018

Related U.S. Application Data
(60) Provisional application No. 62/609,818, filed on Dec. 22, 2017.

(51) Int. Cl. B60P 7/135; B60P 7/08

(52) U.S. Cl. CPC B60P 7/135; B62B 1/268; B60P 7/0807

(57) ABSTRACT

In the counter-top fabrication business, the biggest and most serious problem is the movement of material. The biggest reason for concern is that kitchen countertop pieces, on average, weigh 200 to 400 pounds while islands can weigh up to 1200 pounds. The racks used to transport pieces are normally 4 to 8 inches tall off the ground which is just enough room for the forks of a forklift to raise the rack. Therefore, installers must squat all the way to the ground to lift the pieces. The invention we created is an easy lift kit raising the height of the countertop material as high as possible on the rack while still being able to travel safe. We are lifting the rack as high as possible to get reach what OSHA calls the “power zone” for lifting. We have invented six different designs to accomplish this goal.

### BACKGROUND

| | | |
|---|---|---|
| INVENTOR: | Dennis Ray Dickson | Dennis Ray Dickson |
| | 5620 Ceres Street | PO Box 13514 |
| | Alexandria, LA 71303 | Alexandria, LA 71315 |

In the counter top fabrication business, the biggest and most serious problem is the movement of material. Material must be moved from slab racks to machines for fabrication, then onto a delivery vehicle to be brought to the end user's location and lastly, removed from the vehicle to be installed. The biggest reason for concern is that kitchen countertop pieces, on average, weigh 200 to 400 pounds while islands can weigh up to 1200 pounds. The racks used to transport pieces are normally 4 to 8 inches tall off the ground which is just enough room for the forks of a forklift to raise the rack. Therefore, installers must squat all the way to the ground to lift the pieces. We have been in the countertop fabrication business for the last ten years. Moving this material is a challenge in two ways: we must figure out how to move the material without causing injuries to employees, but also how to do it without breaking or damaging the material. The granite material comes in slabs that are 72 inches by 120 inches, and can weight up to 1200 pounds. Even after the slab is cut up into pieces, it can still weigh anywhere from 200 to 1200 pounds. After we receive the 1200-pound granite slabs from wholesalers, the next step is to lay it down on a saw to cut. A special boom on the forklift is made to handle that much weight. The slabs can be laid over with tension straps, or with a suction hoist hanging form the forklift crane. The last and least safe way to do this would be four men laying the slab down on the saw with their hands. Once the slab has been cut up on the saw, the pieces are then ready to move to the CNC, profiler, or work tables. The finished pieces are now loaded onto the rack located on the truck or trailer using either a pressure clamp or suction hoist on the forklift. Lastly, the pieces must be taken off the rack and into a home or business to be installed. Our invention deals with the last step in this process, making it quicker and much safer to move and remove pieces off the rack.

### BRIEF SUMMARY OF THE INVENTION

The invention we created is an easy lift rack kit. We have invented a lift kit raising the height of the countertop material as high as possible on the rack while still being able to travel safe. It raises the rack from 2 to 18 inches based on the end user's needs. We are lifting the rack as high as possible to get reach what OSHA calls the “power zone” for lifting. While the lift kits are customized to end user's needs, we want the lifting point as high as possible while keeping the top of rack low enough to ensure safe transportation. We have six designs to accomplish this goal:

1) Box and forklift brace design

2) Box design

3) Leg up design

4) Upper angled design

5) Lower angled design

6) Angle to forklift braced design

These designs have a lift kit extension allowing the rack to be lifted in one-inch increments. On top of not having to squat all the way down to pick up the material, there are additional benefits to raising the rack. If raised properly, the rack can be moved with a forklift and placed on a trailer, including those with 12-inch side rails. It also allows drop down pins in each of the four corners that go through holes on the trailer providing an extra degree of safety during transport. Lastly, when the rack is moved from the trailer back to the shop, wheels can quickly be installed by removing the extension pins. The standard racks in the countertop industry are 4 to 6 inches off the ground, designed just high enough so that the forks on a forklift can pick it up. This does not consider the person squatting down to 6 inches to lift 200 to 1200-pound pieces; our lift kits are designed to do just that. We have many heights and six different designs to accomplish this in accordance of the installer's needs. There are three considerations when dealing with this. First, we must decide which height will make the best possible outcome; the ideal height for the installer maximizes his “power zone.” Second, we must be low enough for installers attach straps to the top of the rack, securing the pieces. The average job has 5 to 15 different pieces. When one piece is moved off the rack to be installed, the straps must be reset to keep the pieces secure. Lastly, the height of the rack must allow clearance for the side rails on the trailer. Since the standard utility trailer has 12-inch side rails, the lift kit would need to also be 12 inches tall. At 12 inches, the material is 18 inches off the ground verses 6 inches, moving it into the “power zone.” This will also allow the rack to clear the side rails and fenders on a trailer ensuring that it can be loaded and unloaded properly. At this height, you will still be able to reach the safety straps as needed. Depending on user preference, the lift kits can be secured together three different ways: Nuts and bolts, U-bolts, or welded together.

### BRIEF DESCRIPTION OF DRAWINGS

FIG. 1. Side view with existing rack installed

FIG. 2. Cross view of set of extensions with bottom of existing rack connected

FIG. 3. Side view of box design with U-bolt

FIG. 4. Side view of box design with no forklift plate

FIG. 5. Side view of box design with forklift brackets

FIG. 6. Side view with leg up design

FIG. 7. Side view with angle brace with lower support bar

FIG. 8. Side view with angle brace with upper support bar

FIG. 9. Front view of boxed design with nuts and bolts

FIG. 10. Front view boxed design with U-bolts

FIG. 11. Front view of triangle frame with U-bolts

FIG. 12. Front view of 45-degree angle design with nuts and bolts

FIG. 13. Top view of pair of easy lift kit

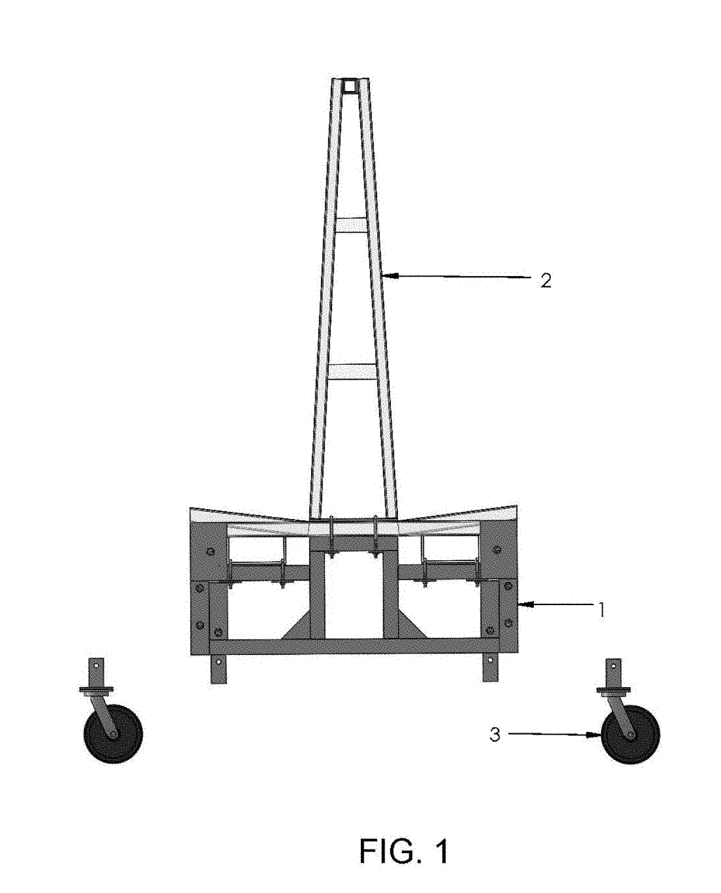

FIG. 1.
1) Side view of easy lift kit
2) Existing rack that mounts on easy lift kit
3) Optional wheels

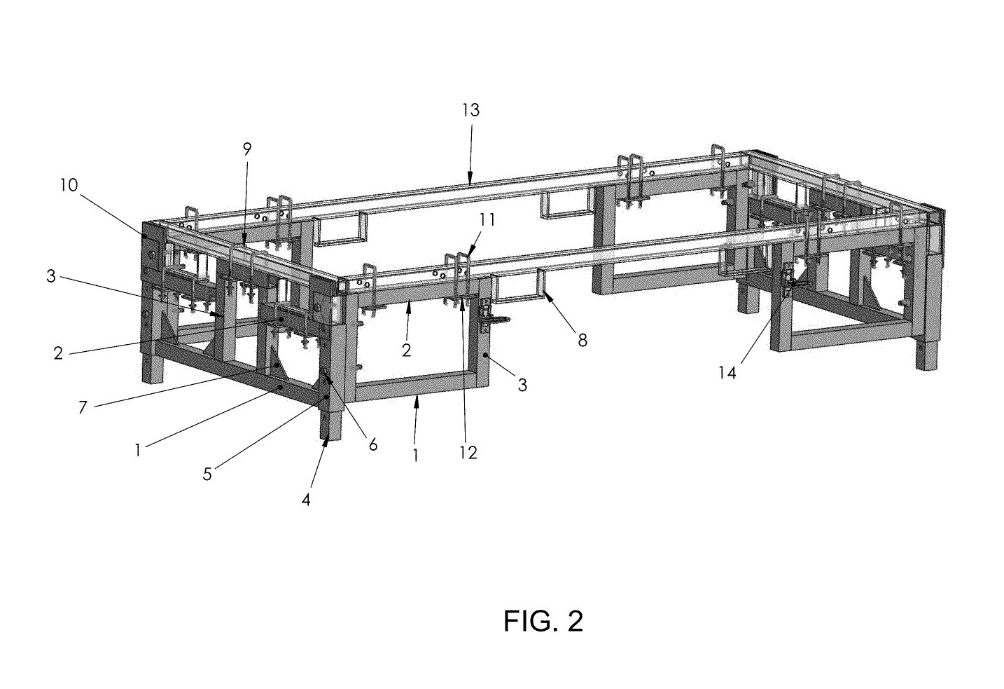

FIG. 2.
1) Lower support bar that sits on floor maximizing surface on floor
2) Upper bar to existing rack
3) Side upright supports
4) Corner piece anchor
5) Corner piece leg
6) Bolt holding corner together
7) Gussets
8) Side forklift slot
9) Top inside center plate
10) Top outer plate
11) Top U-bolts
12) Lower mounting plate
13) Lower base of existing rack sitting on frame
14) Fold-down step

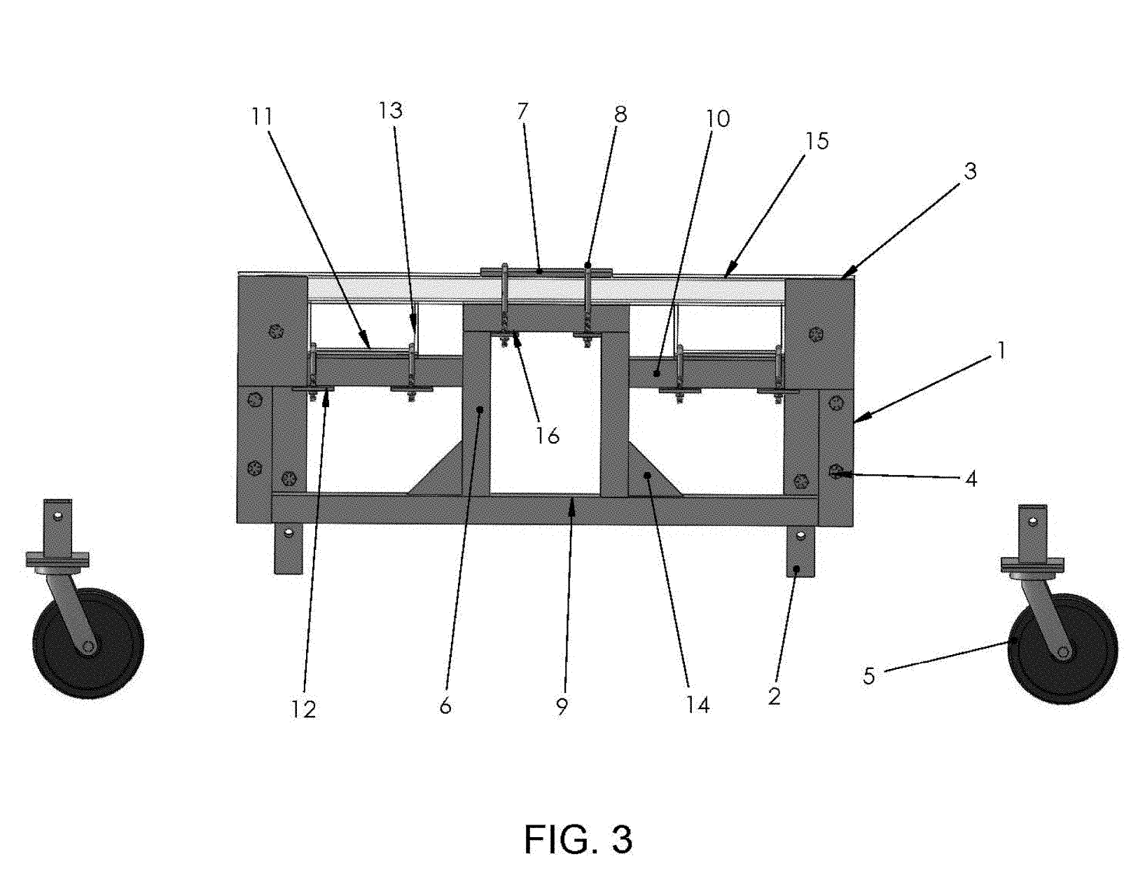

FIG. 3.
1) Square tubing for corner to add stability
2) Leg anchor mounted to secondary tube
3) Welded top plate for mounting the top corner of rack leg allowing the lift kit to be bolted together
4) Bolt through frame leg securing center to both sides
5) Wheel with adapter used in place of leg extension
6) Upright support bar where center mounting plate is welded
7) Mounting plate for center top U-bolt
8) Center top U-bolts
9) Lower support bar that sits on floor maximizing surface on floor
10) Upper support bar where side and mid-bars are attached
11) Top spacer mounted below forklift plate because some racks have legs that are four inches tall, and the plate is 3¾ inch. So, to attach the U-bolt to the plate, a quarter-inch spacer is needed
12) Bottom plate with holes mounted below forklift plate which allows U-bolts to be secured to plate
13) U-bolt through forklift plate and bottom plate to secure kit
14) Gussets providing extra bracing support in corners
15) Bottom of existing rack sitting on floor maximizing surface area contact

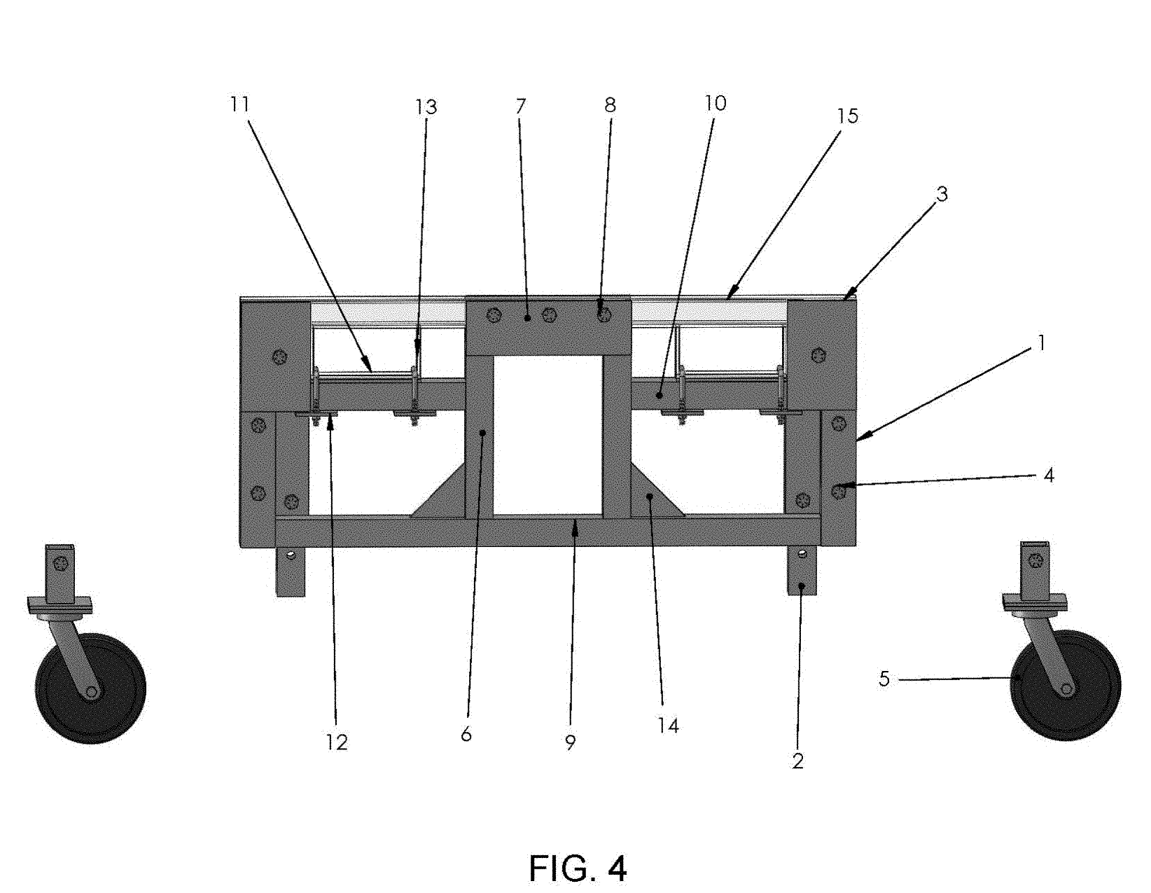

FIG. 4.
1) Square tubing for corner to add stability
2) Leg anchor mounted to secondary tube
3) Welded top plate for mounting the top corner of rack leg allowing the lift kit to be bolted together
4) Bolt through frame leg securing center to both sides
5) Wheel with adapter used in place of leg extension
6) Upright support bar where center mounting plate is welded
7) Center mounting plate
8) Bolts through center mounting plate
9) Lower support bar that sits on floor maximizing surface on floor
10) Upper support bar where side and mid-bars are attached
11) Top spacer mounted below forklift plate because some racks have legs that are four inches tall, and the plate is 3¾ inch. So, to attach the U-bolt to the plate, a quarter-inch spacer is needed
12) Bottom plate with holes mounted below forklift plate which allows U-bolts to be secured to plate
13) U-bolt through forklift plate and bottom plate to secure kit
14) Gussets providing extra bracing support in corners
15) Bottom of existing rack sitting on floor maximizing surface area contact

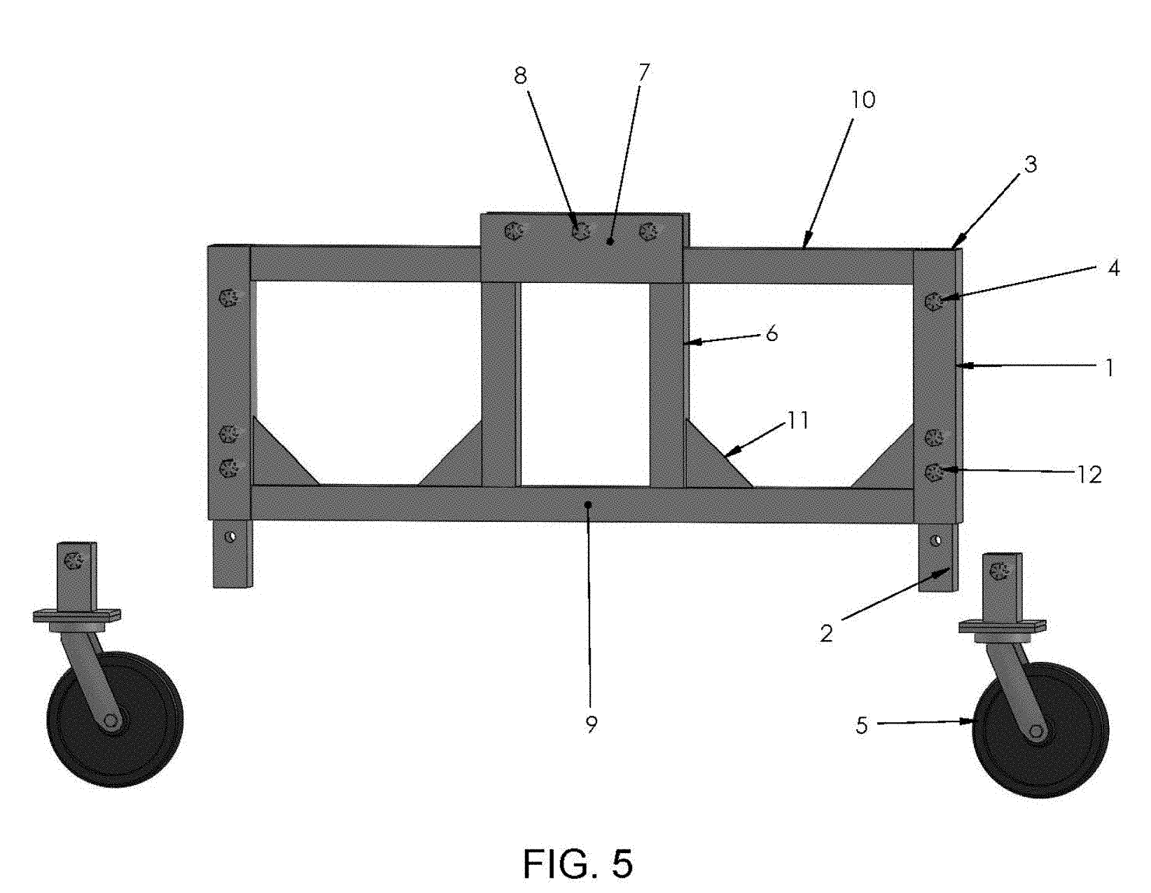

FIG. 5.
1) Square tubing for corner to add stability
2) Leg anchor mounted to secondary tube
3) Top of tubing for existing rack to sit in
4) Bolt through frame leg securing center to both sides
5) Wheel with adapter used in place of leg extension
6) Upright support bar where center mounting plate is welded
7) Center mounting plate
8) Bolts through center mounting plate
9) Lower support bar that sits on floor maximizing surface on floor
10) Upper support bar where side and mid-bars are attached
11) Gussets
12) Bolt attaching drop-down leg

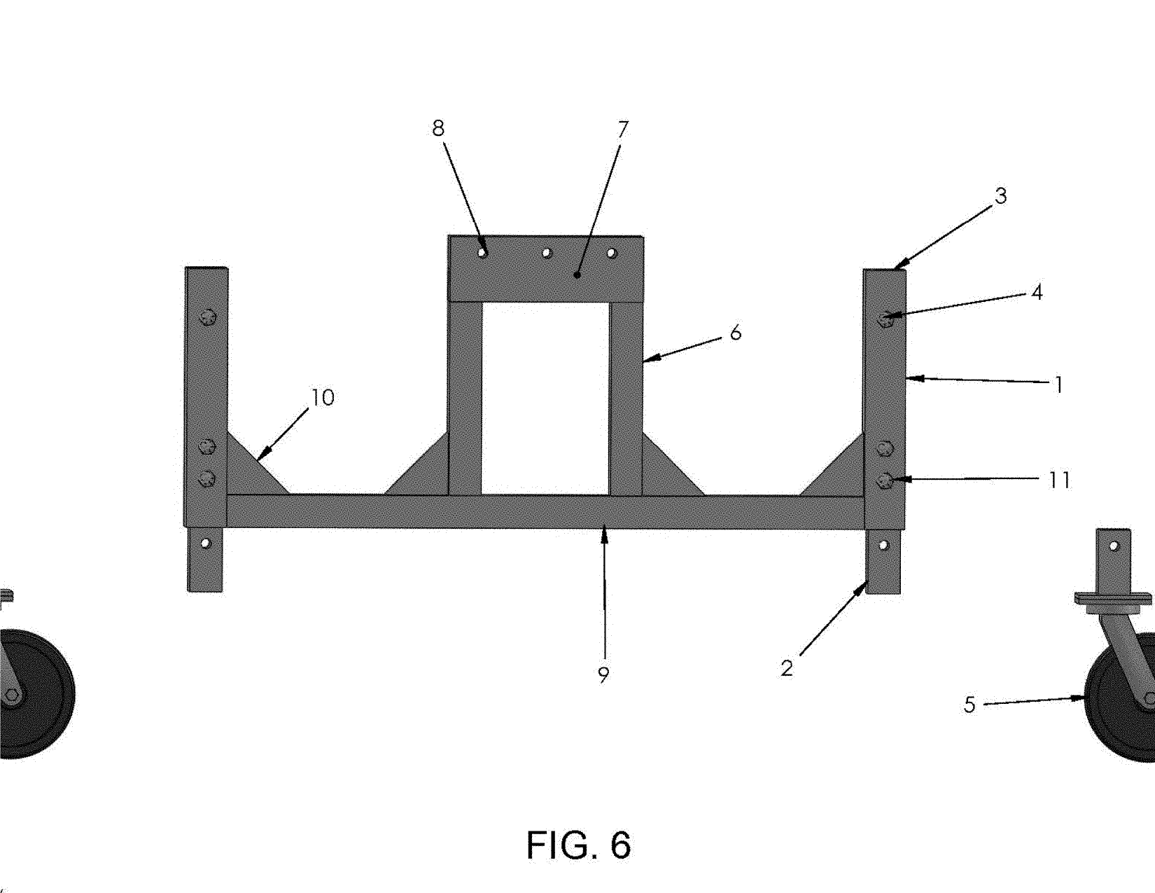

FIG. 6.
1) Square tubing for corner to add stability
2) Leg anchor mounted to secondary tube
3) Top of tubing for existing rack to sit in
4) Bolt through frame leg securing center to both sides
5) Wheel with adapter used in place of leg extension
6) Upright support bar where center mounting plate is welded
7) Mounting plate for center top U-bolt
8) Hole for center bolts
9) Lower support bar that sits on floor maximizing surface on floor
10) Gussets
11) Bolt attaching drop-down leg

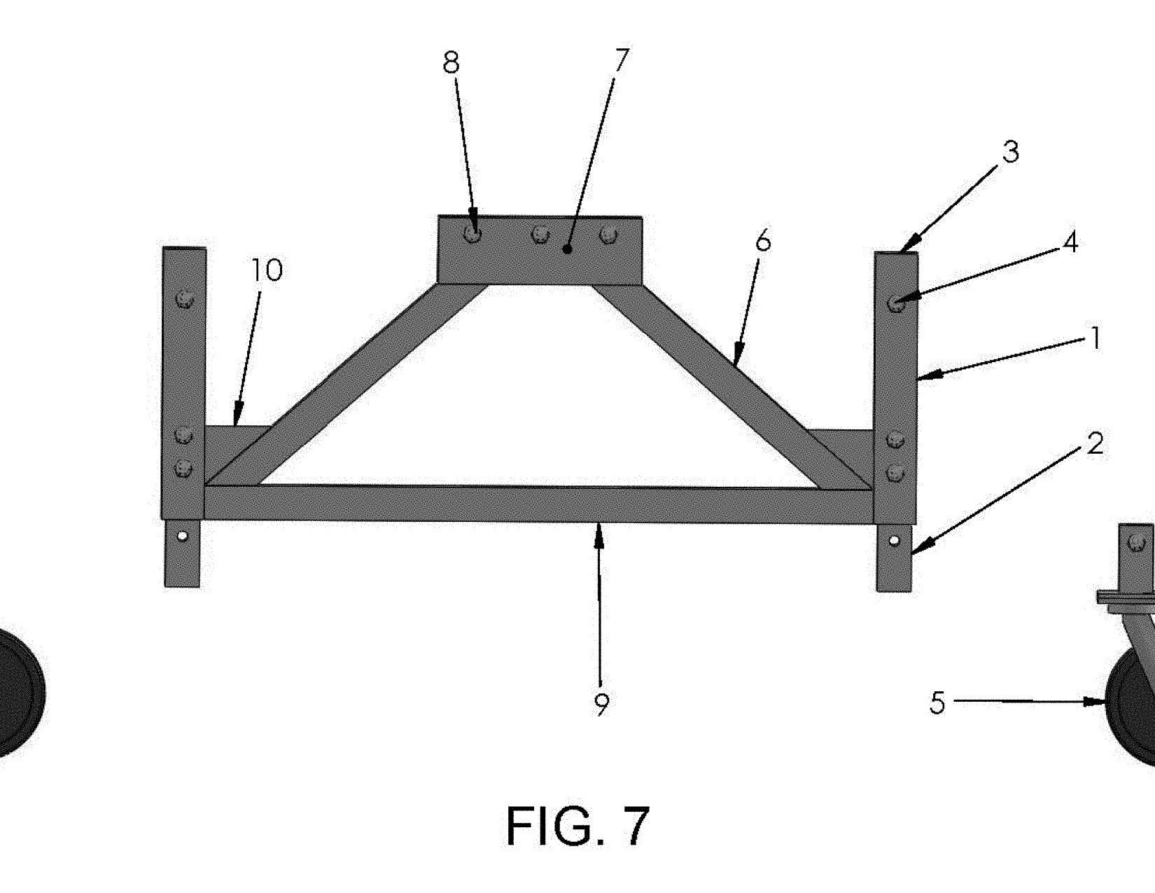

FIG. 7.
1) Square tubing for corner to add stability
2) Leg anchor mounted to secondary tube
3) Top of tubing for existing rack to sit in
4) Bolt through frame leg securing center to both sides
5) Wheel with adapter used in place of leg extension
6) Lower angled support leg
7) Center mounting plate
8) Bolts through center mounting plate
9) Lower support bar that sits on floor maximizing surface on floor
10) Gussets
11) Bolt attaching drop-down leg

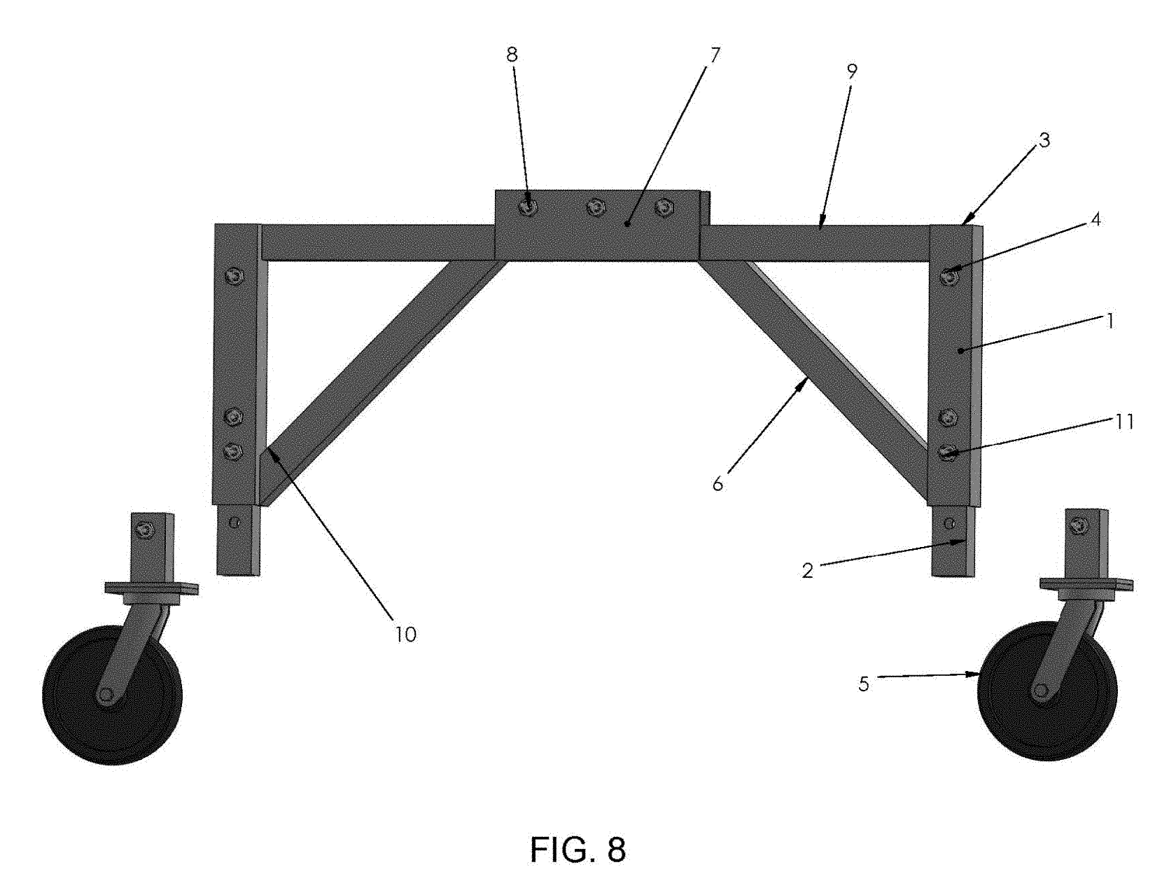

FIG. 8.
1) Square tubing for corner to add stability
2) Leg anchor mounted to secondary tube
3) Top of tubing for existing rack to sit in
4) Bolt through frame leg securing center to both sides
5) Wheel with adapter used in place of leg extension
6) Upper angled support leg
7) Center mounting plate
8) Bolts through center mounting plate
9) Upper support bar where side and mid-bars are attached
10) Gussets
11) Bolt attaching drop-down leg

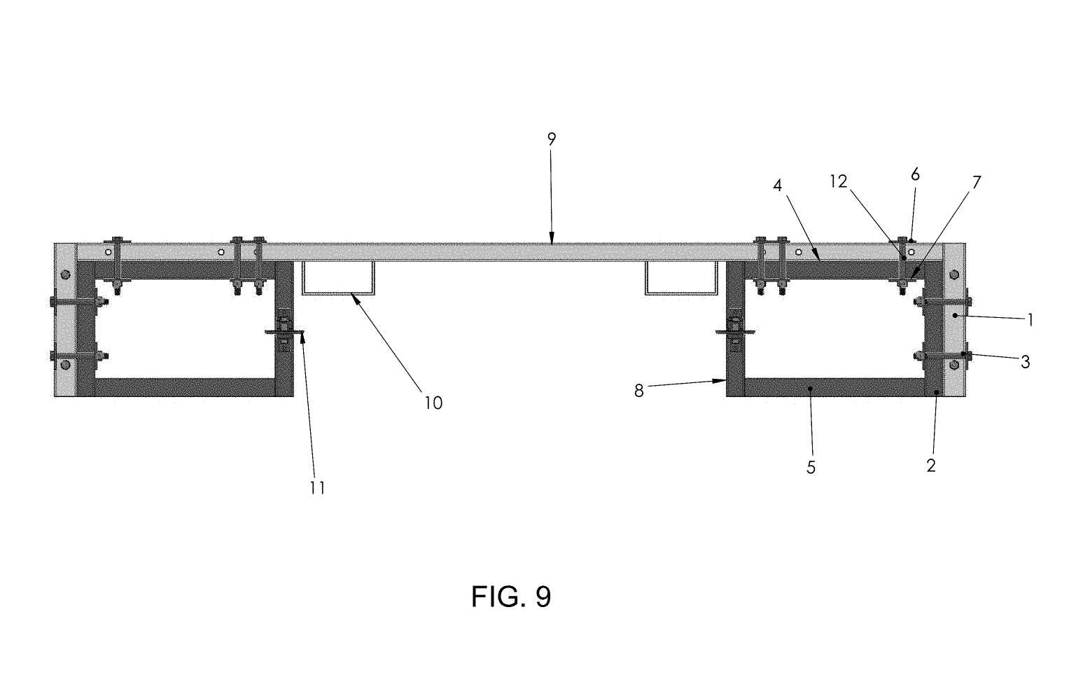

FIG. 9.
1) Existing side leg
2) Inside upper support
3) Bolt holding end and side together
4) Upper mounting plate
5) Lower mounting plate
6) Top upper mounting plate
7) Upper bottom mounting plate
8) Inside mounting support
9) Existing rack
10) Existing forklift hook
11) Fold-down step
12) Bolt going through top plate

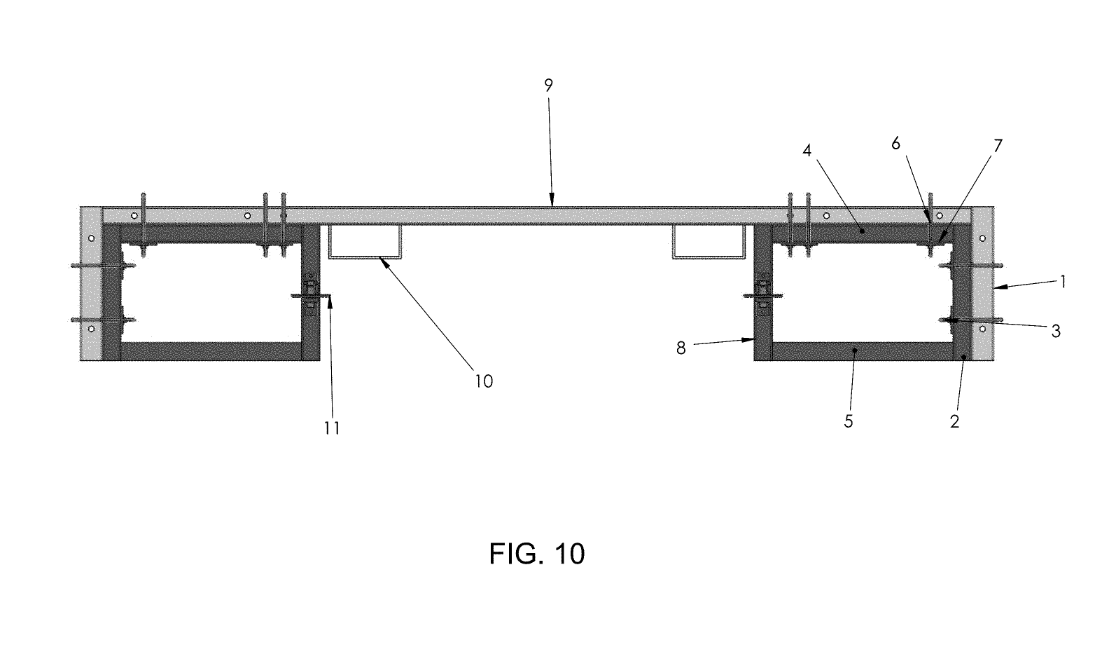

FIG. 10.
1) Existing side leg
2) Inside upper support
3) U-bolt holding end and side together
4) Upper mounting plate
5) Lower mounting plate
6) Top U-bolt
7) Lower bottom mounting plate
8) Inside mounting support
9) Existing rack
10) Existing forklift hook
11) Fold-down step

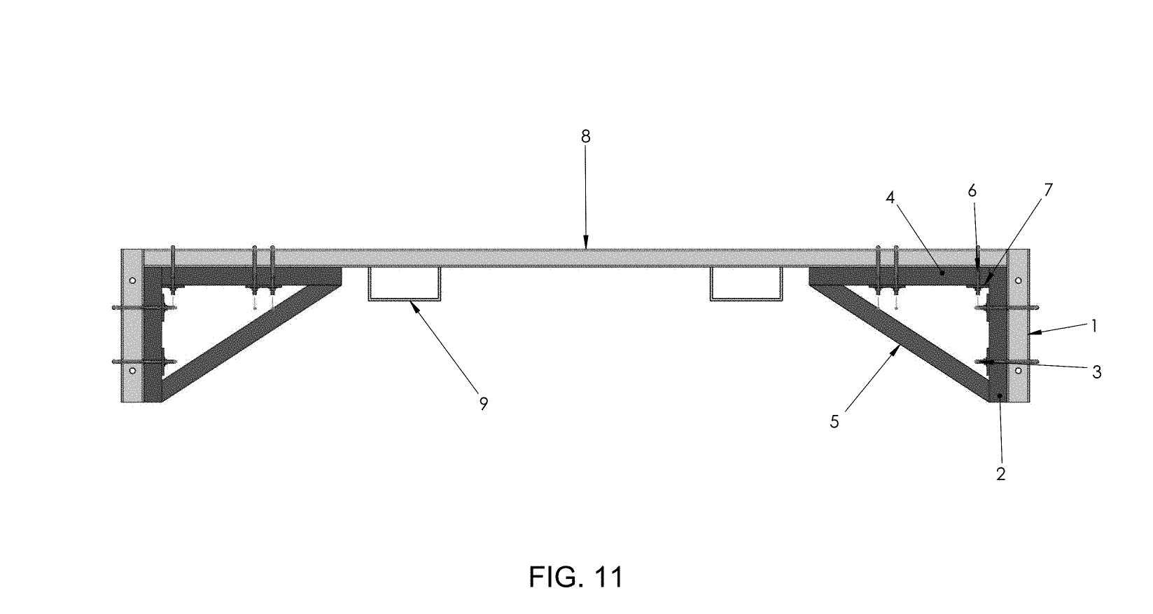

FIG. 11.
1) Existing side leg
2) Inside upper support
3) U-bolt holding end and side together
4) Upper mounting plate
5) Angled support bar
6) Top U-bolt
7) Lower bottom mounting plate
8) Existing rack
9) Existing forklift hook

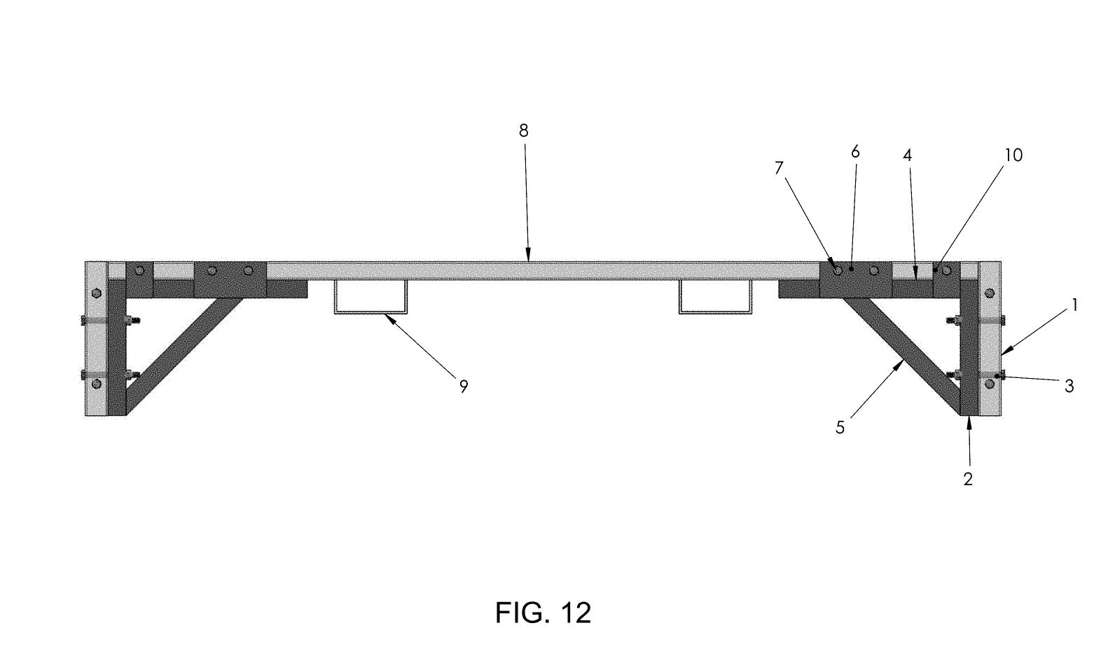

FIG. 12.
1) Existing side leg
2) Inside upper support
3) Nut and bolt holding end and side together
4) Upper support beam
5) Angled support bar
6) Top mounting plate
7) Bolt through top mounting plate
8) Existing rack
9) Existing forklift hook
10) Single-hole upper mounting plate

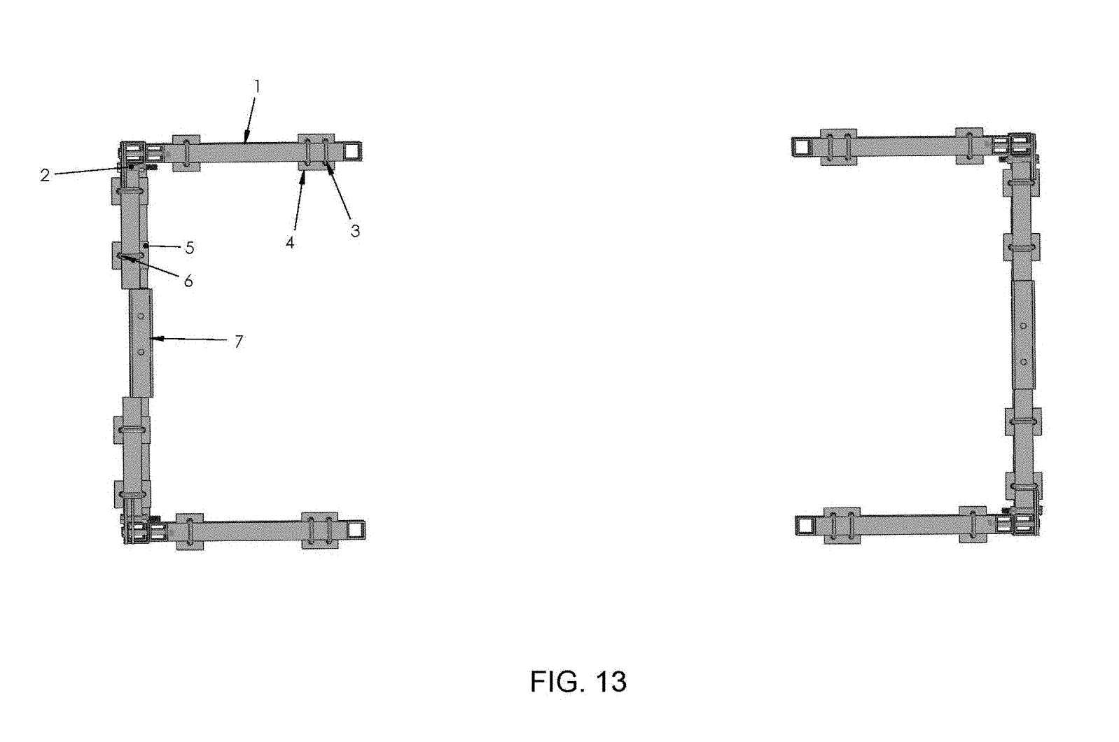

FIG. 13.
1) Upper support bar
2) Nut and bolt through top corner plate securing end and side piece together.
3) Upper U-Bolt
4) Lower mounting plate for U-bolt
5) Mounting plate for U-bolt
6) Side U-bolt
7) Upper centered mounting plates

1. A lift kit system for racks, comprised: metal supports bolted and or welded together to lift racks off the ground to reach what OSHA calls the power zone for safe lifting.

2. A lift kit system in claim #1, including: a lift kit with six distinct configurations engineered for existing racks including; a box and forklift brace design; a box design, a leg up design; an upper angled design; a lower angled design; and an angle to forklift braced design.

3. A lift kit system in #1, further comprised: of sleeves in each corner to mount safety stops for use on trailers and wheels for use off-trailer.

4. A lift kit system, comprised: of metal supports bolted and or welded together to raise racks high enough to clear side rails of trailer.

5. A lift kit system in claim #4, comprised: of lift points for forklift to raise racks above side rails on trailers for safe and quick loading and unloading.
